(19) United States
(12) Patent Application Publication
(10) Pub. No.: US 2011/0123008 A1
(43) Pub. Date: May 26, 2011

(54) Method and apparatus for telecommunication session authentication using DTMF signaling

(76) Inventor: Tomasz Sarnowski, Keyport, NJ (US)

(21) Appl. No.: 12/592,372

(22) Filed: Nov. 24, 2009

(51) Int. Cl. H04M 11/00

(52) U.S. Cl. 379/93.02

(57) ABSTRACT

Method and system for authenticating a telecommunication session request provides the steps of receiving the telecommunication session request, sending an authentication trigger request, receiving at least one authentication character encoded by a DTMF tone that is not capable of being generated via a keypad stroke and performing an authentication operation upon the at least one received authentication character. In one embodiment of the invention, the at least one authentication character is a string of authentication characters. The string may further include a first non-numeric DTMF tone (indicative of the beginning of the string of authentication characters), one or more alpha-numeric DTMF tones and a second non-numeric DTMF tone (indicative of the end of the string of authentication characters). Additional information may also be appended to the at least one authentication character during the receiving step (i.e., callerID information or a destination number for the telecommunication session).

### FIELD OF THE INVENTION

The invention is related to the field of telecommunication devices and services and more specifically, the invention is directed to a method and apparatus for authenticating a telecommunication session from a PSTN-based wireless client device into a VoIP network.

### BACKGROUND OF THE INVENTION

Voice over IP (VoIP) is a technological development in the field of telecommunications that is utilized to establish and provide voice communications over a data network using the Internet Protocol (IP). Entities (e.g., businesses or individuals) implement VoIP by purchasing and installing the necessary equipment (e.g., one or more Customer Premise Equipment (CPE) devices) and service (i.e., a “high speed” network or broadband connection) to access a VoIP service provider and activating this telecommunication service. Since VoIP is a relatively new technology in terms of its commercial penetration, it has yet to completely supplant the existing and traditional telecommunications system more commonly referred to as the Public Switched Telephone Network (PSTN) or Plain Old Telephone Service (POTS). This is particularly notable in the wireless telecommunications space where cellular telephones, towers and satellites have augmented the “reach” of the PSTN beyond traditional land lines by operating according to wireless communications protocols such as Global System for Mobile communications (GSM) and the like. Accordingly, there is a huge amount of existing PSTN equipment that entities are reluctant to completely abandon for economic and strategic reasons. To further complicate matters, VoIP-based devices and existing PSTN-based devices are not compatible; thus, an entity desiring to exploit VoIP in a wireless environment would have to purchase additional equipment having the appropriate communications protocols such as IEEE 802.11 (also known as Wi-Fi).

To address this shortcoming, mobile telephones containing both cellular and non-cellular radios used for voice and data communication have been developed. Such dual mode phones use cellular radio which will contain GSM/CDMA/W-CDMA (normal and/or wideband code division multiple access) as well as other technology like (Wi-Fi) radio or DECT (Digital Enhanced Cordless Telecommunications) radio. These phones can be used as cellular phones when connected to a wide area cellular network and, when within range of a suitable WiFi or DECT network, these phones can be used as a WiFi/DECT phones. This dual mode of operation capability can reduce cost (for both the network operator and the subscriber), improve indoor coverage and increase data access speeds. However, a VoIP-capable dual mode telephone must be provisioned using methods beyond the out-of-band methods used by the cellular network which adds to the complexity of operation. Further, consumers may be unwilling to purchase dual mode equipment if there is a measurably higher acquisition cost associated therewith.

Additionally, in determining the best way to provide individuals with the ability to utilize VoIP, there is an underlying concern of how to determine the authenticity of the customer or device attempting to place a call that originates on a traditional PSTN or mobile network. It has been realized that various fraudulent methods exist to gain access to a telephony network such as caller ID spoofing, unauthorized acquisition of user-keyed passwords and the like. Therefore, there is a need in the art for a method and apparatus for authenticating VoIP telecommunication sessions when such sessions are originating from a non-VoIP network.

### SUMMARY OF THE INVENTION

The disadvantages associated with the prior art are overcome by a method and system for authenticating a telecommunication session request. The invention provides the steps of receiving the telecommunication session request, sending an authentication trigger request, receiving at least one authentication character encoded by a DTMF tone that is not generated via a keypad stroke and performing an authentication operation upon the at least one received authentication character. In one embodiment of the invention, the at least one authentication character is a string of authentication characters. The string of authentication characters may further include a first non-numeric DTMF tone, one or more alpha-numeric DTMF tones and a second non-numeric DTMF tone. In this particular scheme, the first non-numeric DTMF tone is indicative of the beginning of the string of authentication characters, the one or more alpha-numeric DTMF tones is the string of authentication characters and the second non-numeric DTMF tone is indicative of the end of the string of authentication characters. Additional information may also be appended to the at least one authentication character during the receiving step (i.e., callerID information or a destination number for the telecommunication session).

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system level representation of a network or networks that interact with each other to perform authentication of VoIP telecommunication sessions in accordance with the subject invention;

FIG. 2 depicts a series of method steps for authenticating VoIP telecommunication sessions in accordance with the subject invention;

FIG. 3 depicts a representational diagram of a DTMF keypad including hidden tones as used in accordance with the subject invention;

FIG. 4 depicts a call flow diagram for executing a telecommunication session including authentication in accordance with the subject invention; and

FIG. 5 depicts a schematic diagram of a controller that may be used to practice one or more embodiments of the present invention;

To facilitate understanding, identical reference numerals have been used, where possible, to designate identical elements that are common to the figures.

### DETAILED DESCRIPTION

Generally, an authentication password for a call request from an originating non-VoIP network (mobile or PSTN) is passed from an end device to a core VoIP call processing network using DTMF. The original call first connects to an authentication system prior to passing the authentication information to complete the call. The authentication process can be strengthened by requiring the end device to include the calling party phone number in the DTMF to avoid authenticating against fraudulent access and call activity (via spoofed caller ID or other methods). In one scenario described in greater detail below, both the calling party telephone number and the authentication password must be sent via DTMF.

The authentication process is executed by an application operating on an originating network handset or similar device when inter-network calling is desired. Upon sending the required information, the application residing on the handset or end point wraps the authentication parameters using “hidden” DTMF tones known as A, B, C, and D tones to define the beginning and the end of the authentication information. Hidden DTMF tones are known to those skilled in the art as seen by the International Telecommunications Union document ITU-T Recommendation Q.23 entitled, “Technical Features of Push-Button Telephone Sets” (1993) and is herein incorporated by reference. The significance to this approach is that the A, B, C, and D DTMF tones are not physically present on modern handsets which make it harder to compromise or spoof these particular keys/tones as they are not generated by keypad operation. Rather, the ability to generate these tones is present on the software residing on the telephony handsets or otherwise not readily accessible or operable by physical manipulation of a device keypad. Once the authentication information is passed and verified, the final leg of the call is established.

As part of the call processing is conducted by non-traditional means (i.e. over a packet-based or VoIP network), signaling and call set up is not performed exclusively by the traditional means governed by ISDN and POTS. Signaling that is conducted in the packet-based network(s) is preferably executed using Session Initiation Protocol (SIP). SIP is a popular communication protocol for initiating, managing and terminating media (e.g., voice, data and video) sessions across packet based networks that typically use the Internet Protocol (IP) of which VOIP is an example. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection allowing users to initiate and receive communication from any location.

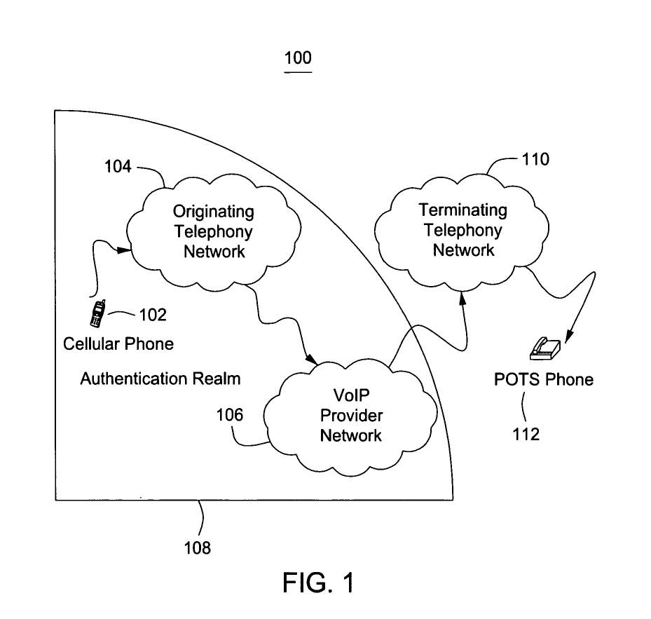

FIG. 1 depicts a system 100 comprised of a network or networks that interact with each other to perform authentication of VoIP telecommunication sessions in accordance with the subject invention. The system 100 further comprises an originating telephony network 104 from which the originating call request is made. Such originating telephony network 104 may be for example a mobile network accessed by a user via a user access device (i.e., mobile telephone) 102, although other networks are contemplated. The call request is passed to a VoIP provider network 106 where an authentication process is performed to verify the authenticity of the user or device accessing the VoIP provider network 106 prior to call establishment. As such, the originating telephony network 104, user access device 102, although other networks are considered to form an authentication realm 108 whereby call requests must pass prior to termination.

If call requests successfully pass through the authentication realm 108, they are passed to a terminating telephony network 110 which services termination point 112. In one example, the terminating telephony network 110 is a PSTN network and the termination point 112 is a PSTN handset.

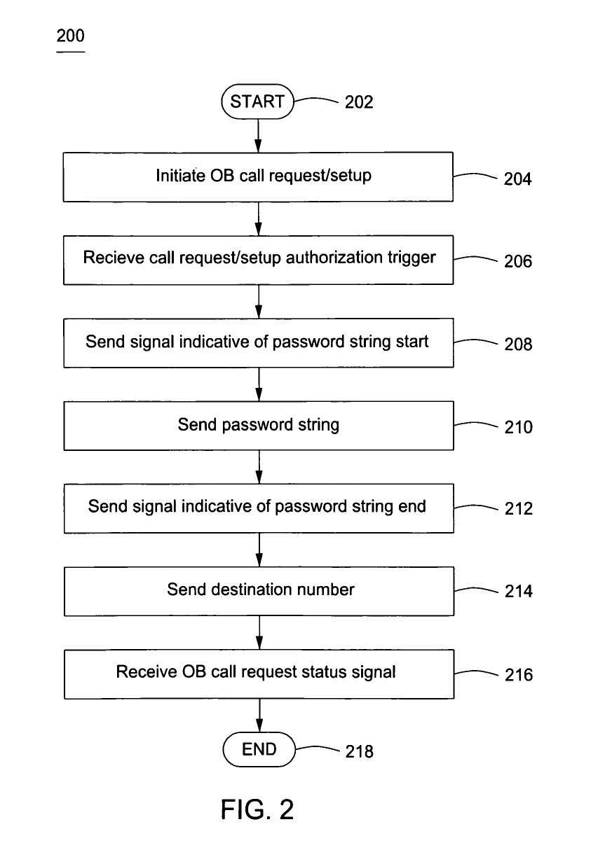

FIG. 2 depicts a series of method steps 200 for authenticating VoIP telecommunication sessions in accordance with the subject invention. The method starts at step 202 and proceeds to step 204 where an inter-network call request is initiated. Such call request/set up involves the user device 102 performing operations to access a VoIP network 106 via the originating network 104. One example of such operation is by using an anchoring number or other similar two step dialing process. In such a process, a user enters a destination number which is recognized by the user access device 102 to be an inter-network destination number. As such, the user device “dials” the anchoring number to access the originating network 104 and pass the call request through to the VoIP provider network 106. Once inside the VoIP provider network 106, the call request is processed by one or more call proxy devices (servers) not shown.

At step 206, one of the proxy devices tasked with processing the call request, sends signaling back to the user access device 102 indicative of an authentication request. This signaling acts as a trigger for the user device 102 to send authentication information. In one embodiment of the invention, the signaling is a SIP message (i.e., a 200 OK message, though other messages are contemplated). The SIP message terminates and is converted by VoIP network equipment into a return originating network signal indicative of the authentication request (i.e., an ISDN based signal such as “connect” or an SS7 signal). Such return originating network signal eventually reaches the user access device 102 which interprets same as an authentication trigger.

At step 208, the user access device 102 sends signaling back to the proxy devices indicative of the beginning of a password string. This signaling notifies the appropriate devices in the authentication realm 108 that authentication information follows. In one embodiment of the invention, the signaling is one or more of a plurality of hidden DTMF tones as described above. More specifically, the DTMF tone(s) are passed via the originating network 104, converted by the VoIP provider network 106 to a SIP message indicative of the DTMF tone(s) and passed to the appropriate devices for authentication purposes (i.e., one or more proxy devices linked to an authentication database). In one embodiment of the invention, the DTMF tone is tone “A” and the tone is converted into a SIP message selected from the group consisting of a NOTIFY and an INFO message, though other messages are contemplated.

At step 210, the password string is sent to the VoIP provider network 106. This step is, in one embodiment of the invention, a repeated series of steps whereby a single password character is sent through the authentication realm 108 and confirmed by appropriate signaling at the junction between the originating network 104 and the VoIP provider network 106 before the next password character is sent. Preferably, the password string a plurality of alphanumeric characters that are easily identifiable via normal (unhidden) DTMF tones and keypad sequencing.

At step 212, the user access device 102 sends signaling back to the proxy devices indicative of the end of the password string. This signaling notifies the appropriate devices in the authentication realm 108 that authentication information has ended. In one embodiment of the invention, the signaling is one or more of a plurality of hidden DTMF tones as described above. More specifically, the DTMF tone(s) are passed via the originating network 104, converted by the VoIP provider network 106 to a SIP message indicative of the DTMF tone(s) and passed to the appropriate devices for authentication purposes (i.e., one or more proxy devices linked to an authentication database). In one embodiment of the invention, the DTMF tone is tone “B” and the tone is converted into a SIP message selected from the group consisting of a NOTIFY and an INFO message, though other messages are contemplated.

At step 214, the user access device 102 sends signaling back to the authentication realm 108 indicative of the destination number that the user desires to have his call terminated. Such information is for example passed via the originating network 104, converted by the VoIP provider network 106 to a SIP message indicative of the destination number and passed to the appropriate devices (i.e., one or more proxy devices for performing call termination) to determine the proper terminating telephony network 110 for call termination to termination point 112.

At step 216, the user access device 102 receives a call request status signal. Particularly, when the VoIP network 106 has established the appropriate connections to terminate the call, a SIP message (in the VoIP network 106) is relayed and converted to signaling (in the originating network 104) which is indicative of the call status. Such signaling includes but is not limited to ringing, busy and voicemail redirect announcement. The method ends at step 218.

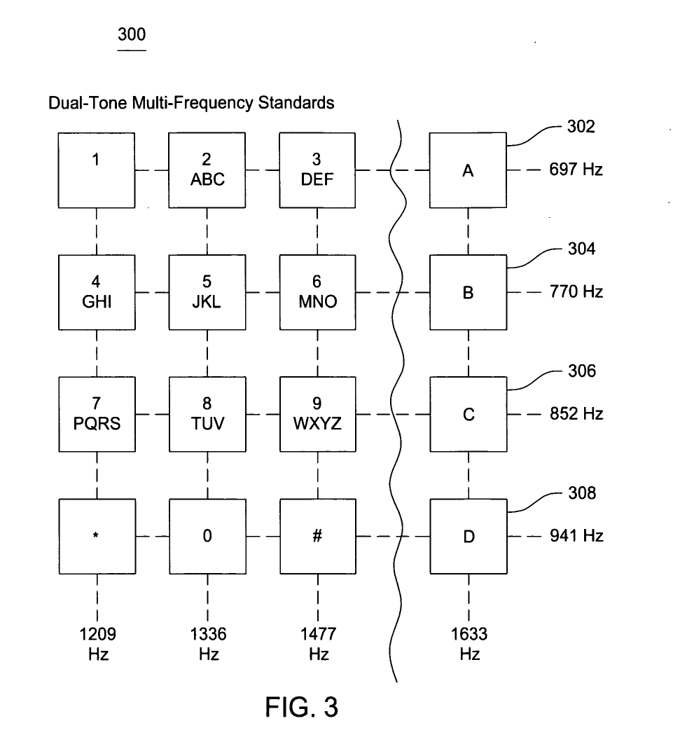

As previously discussed, the invention utilizes four hidden DTMF frequencies that are available via traditional telephony systems and uses them to wrap or present a secure password. FIG. 3 depicts a representational diagram of a DTMF keypad 300 including hidden tones as used in accordance with the subject invention. The four frequencies are represented as A (697/1633 Hz) 302, B (770/1633 Hz) 304, C (852/1633 Hz) 306, and D (941/1633 Hz) 308. As an alternate embodiment of the invention, the calling parties Direct Inward Dialing (DID) phone number can also be included in the DTMF authentication process. This approach minimizes the chance of fraudulent network access.

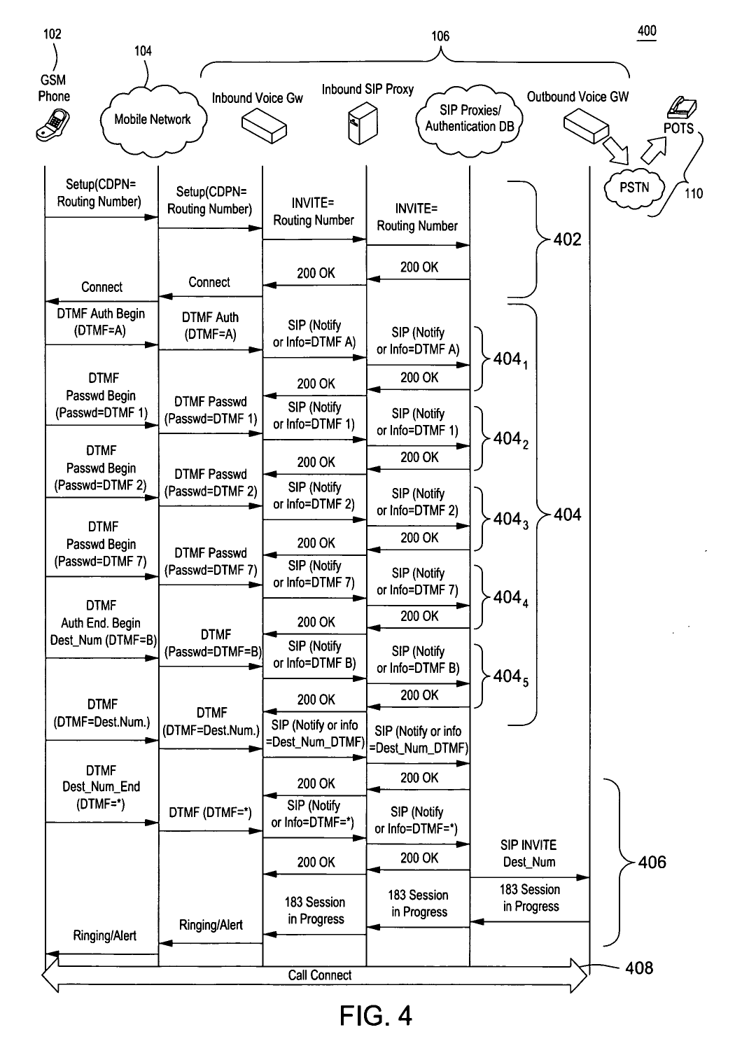

FIG. 4 depicts a call flow diagram 400 for executing a telecommunication session including authentication in accordance with the subject invention. The call flow diagram shows the various legs of a call during the call request/set up period 402, authentication process 404, destination number termination resolution and signaling process 406 and eventual communication session 408. Each leg of the call is identified via the network (or component thereof) that it passes through including the user access device 102, originating network 104, VoIP network 106 and terminating network. For example, the call request/set up period 402 approximately corresponds to steps 204 and 206 described above with respect to dialing into the originating network 104 and accessing the VoIP provider network 106. Such actions are accomplished by a combination of PSTN and SIP signaling as the call setup request traverses the different telephony networks (such as, but not limited to those seen in FIG. 1). The authentication process 404 is further broken down into a repeating series of password character movements from the various networks via appropriate signaling protocols and a response to each such movement. In one embodiment, a DTMF tone is passed from PSTN signaling protocols to SIP signaling protocols with a SIP 200 (“OK”) response prior to the sending of the next password character. In a first character movement 404₁, a “Begin” tone (e.g., DTMF tone A) is passed and acknowledged. In a second character movement 404₂, a first password character tone (e.g., DTMF tone 1) is passed and acknowledged. In a third character movement 404₃, a second password character tone (e.g., DTMF tone 2) is passed and acknowledged. In a fourth character movement 404₄, a third password character tone (e.g., DTMF tone 7) is passed and acknowledged. In a fifth character movement 404₅, an “End” tone (e.g., DTMF tone B) is passed and acknowledged. Although five characters are described as being passed and acknowledged, one skilled in the art understands that any number of characters may be passed with a mix of hidden and unhidden tones representing same for increased password strength, changes in authentication protocols or any other reason for the purposes of completing the authentication of the user and/or device as discussed above.

The primary advantage of this authentication method is that it requires the use of DTMF digits/tones that are not physically present on modern handsets. Although these digits are not physically available on handsets, the DTMF tones they would represent are still valid and can be used for signaling across telephony networks. This makes it very difficult to compromise the authentication process between the handset and the IP based authentication servers. As an additional precaution, the caller ID information may also be passed via the traditional DTMF tones available on all handsets. If the caller ID information is not passed via DTMF, the caller ID information received in the call setup messages will be used.

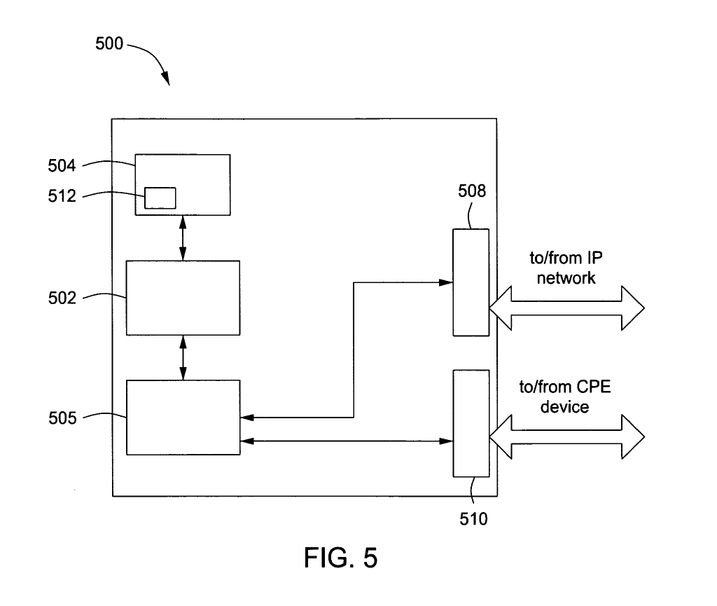

FIG. 5 depicts a schematic diagram of a controller that may be used to practice one or more embodiments of the present invention. Any one, combination or all of the servers identified in the above Figures and discussed herein can function as a controller that may be used to practice the present invention. Alternately and preferably, the user access device 102 can also function as a controller for performing the call processing in the manner described. The details of such a device are depicted in FIG. 5 as controller 500.

The controller 500 may be one of any form of a general purpose computer processor used in accessing an IP-based network such as the LAN/WAN presented above, a corporate intranet, the Internet or the like. The controller 500 comprises a central processing unit (CPU) 502, a memory 504, and support circuits 505 for the CPU 502. The controller 500 also includes provisions 508/510 for connecting the controller 500 to databases, customer equipment and/or service provider agent equipment and the one or more input/output devices (not shown) for accessing the controller 500 and/or performing ancillary or administrative functions related thereto. Note that the provisions 508/510 are shown as separate bus structures in FIG. 5; however, they may alternately be a single bus structure without degrading or otherwise changing the intended operability of the controller 500 or invention in general. Additionally, the controller 500 and its operating components and programming as described in detail below are shown as a single entity; however, the controller may also be one or more controllers and programming modules interspersed around a system each carrying out a specific or dedicated portion of the name translation process. By way of non-limiting example, a portion of the controller 500 or software operations may occur at the user access device 102 of FIG. 1 and another a portion of the controller 500 or software operations may occur at the VoIP network 106 of FIG. 1. Other configurations of the controller and controller programming are known and understood by those skilled in the art.

The memory 504 is coupled to the CPU 502. The memory 505, or computer-readable medium, may be one or more of readily available memory such as random access memory (RAM), read only memory (ROM), floppy disk, hard disk, flash memory or any other form of digital storage, local or remote. The support circuits 505 are coupled to the CPU 502 for supporting the processor in a conventional manner. These circuits include cache, power supplies, clock circuits, input/output circuitry and subsystems, and the like. A software routine 512, when executed by the CPU 502, causes the controller 500 to perform processes of the present invention and is generally stored in the memory 504. The software routine 512 may also be stored and/or executed by a second CPU (not shown) that is remotely located from the hardware being controlled by the CPU 502.

The software routine 512 is executed when a preferred method of name translation is desired. The software routine 512, when executed by the CPU 502, transforms the general purpose computer into a specific purpose computer (controller) 500 that controls the interaction with one or more customer databases of, for example, FIG. 1. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 512 of the present invention is capable of being executed on computer operating systems including but not limited to Microsoft Windows 98, Microsoft Windows XP, Apple OS X and Linux. Similarly, the software routine 512 of the present invention is capable of being performed using CPU architectures including but not limited to Apple Power PC, Intel x85, Sun service provider agentRC and Intel ARM.

While foregoing is directed to embodiments of the present invention, other and further embodiments of the invention may be devised without departing from the basic scope thereof, and the scope thereof.

What is claimed is:

1. A method for authenticating a telecommunication session request comprising:
receiving the telecommunication session request;
sending an authentication trigger request;
receiving at least one authentication character encoded by a DTMF tone that is not generated via a keypad stroke; and
performing an authentication operation upon said at least one received authentication character.

2. The method of claim 1 wherein said at least one authentication character is a string of authentication characters.

3. The method of claim 2 wherein said string of authentication characters further comprises:
a first non-numeric DTMF tone;
one or more alpha-numeric DTMF tones; and
a second non-numeric DTMF tone.

4. The method of claim 3 wherein the first non-numeric DTMF tone is indicative of the beginning of the string of authentication characters.

5. The method of claim 3 wherein the one or more alpha-numeric DTMF tones is the string of authentication characters.

6. The method of claim 3 wherein the second non-numeric DTMF tone is indicative of the end of the string of authentication characters.

7. The method of claim 1 wherein additional information is appended to the at least one authentication character during the receiving step.

8. The method of claim 7 wherein the additional information is selected from the group consisting of callerID information and a destination number for the telecommunication session.

9. A computer readable medium storing a software program that, when executed by a computer, causes the computer to perform an operation of authenticating a telecommunication session request comprising:
receiving the telecommunication session request;
sending an authentication trigger request;
receiving at least one authentication character encoded by a DTMF tone that is not capable of being generated via a keypad stroke; and
performing an authentication operation upon said at least one received authentication character.

10. The computer readable medium of claim 9 wherein said at least one authentication character is a string of authentication characters.

11. The computer readable medium of claim 10 wherein said string of authentication characters further comprises:
a first non-numeric DTMF tone;
one or more alpha-numeric DTMF tones; and
a second non-numeric DTMF tone.

12. The computer readable medium of claim 11 wherein the first non-numeric DTMF tone is indicative of the beginning of the string of authentication characters.

13. The computer readable medium of claim 11 wherein the one or more alpha-numeric DTMF tones is the string of authentication characters.

14. The computer readable medium of claim 11 wherein the second non-numeric DTMF tone is indicative of the end of the string of authentication characters.

15. The computer readable medium of claim 9 wherein additional information is appended to the at least one authentication character during the receiving step.

16. The computer readable medium of claim 15 wherein the additional information is selected from the group consisting of callerID information and a destination number for the telecommunication session.

17. A method for password transmission comprising:
sending at least a first signal encoded by a DTMF tone that is representative of a non-numeric value;
sending one or more authentication characters that is representative of the password; and
sending at least a second signal encoded by a DTMF tone that is representative of a non-numeric value.

18. The method of claim 17 further comprising the step of
performing an authentication operation upon said one or more sent authentication characters to validate a telecommunication session.

19. The method of claim 17 wherein the first and second signals encoded by DTMF tones are not generated by virtue of operation of a keypad associated with a device sending said signals.

20. The method of claim 17 wherein the one or more authentication characters are encoded by DTMF tones that are representative of numeric value.
